(19) United States
(12) Patent Application Publication
(10) Pub. No.: US 2019/0302371 A1
(43) Pub. Date: Oct. 3, 2019

(54) FLEXIBLE FIBER OPTIC CIRCUITS AND METHODS OF MANUFACTURING THE SAME

(71) Applicant: COMMSCOPE TECHNOLOGIES LLC, Hickory, NC (US)

(72) Inventors: Laurens Izaäk VAN WUIJCKHUIJSE, Eden Prairie, MN (US); Pieter STIENSTRA, Eindhoven (BE); Adrianus Wilhelmus VAN UDEN, Schijndel (BE); Johan GEENS, Bunsbeek (BE)

(73) Assignee: COMMSCOPE TECHNOLOGIES LLC, Hickory, NC (US)

(21) Appl. No.: 16/348,098

(22) PCT Filed: Nov. 6, 2017
(86) PCT No.: PCT/US2017/060176

§ 371 Date: May 7, 2019

Related U.S. Application Data
(60) Provisional application No. 62/418,418, filed on Nov. 7, 2016.

(51) Int. Cl. G02B 6/36; G02B 6/38; G02B 6/44; G02B 6/42; G02B 6/255

(52) U.S. Cl. CPC G02B 6/3608; G02B 6/3801; G02B 6/3846; G02B 6/4403; G02B 6/3887; G02B 6/3869; G02B 6/4281; G02B 6/255; G02B 6/3885; G02B 6/3825

(57) ABSTRACT

Flexible optical circuits and methods of providing the same in which routing of optical fibers on a flexible substrate is performed after optical fiber ends have been processed. In some embodiments, the methods include fiber splicing operations that can be performed on the pre-processed optical fibers before or after the fibers have been routed on the flexible substrate.

### CROSS-REFERENCE TO RELATED APPLICATION

This application is being filed on Nov. 6, 2017 as a PCT International Patent Application and claims the benefit of U.S. Patent Application Ser. No. 62/418,418, filed on Nov. 7, 2016, the disclosure of which is incorporated herein by reference in its entirety.

### BACKGROUND OF THE INVENTION

As demand for telecommunications increases, fiber optic networks are being extended in more and more areas. Ease of manufacturing network components is an important concern. As a result, there is a need for systems, methods and devices which address this and other concerns.

### SUMMARY

An aspect of the disclosure relates to a method of making a flexible optical circuit device, the flexible optical circuit device including a flexible planar substrate supporting a plurality of optical fibers secured to the flexible planar substrate, the flexible optical circuit device also including ferrules in which the optical fibers are secured, the ferrules including front end faces and the optical fibers including front ends positioned adjacent to the front end faces, the method comprising processing the front ends of the optical fibers before the ferrules are incorporated as part of the flexible optical circuit device and after the optical fibers have been secured within the ferrules.

According to the another aspect of the present disclosure, a method of making a flexible optical circuit device is provided, the flexible optical circuit device including a flexible substrate supporting at least one optical fiber secured to the flexible substrate, each of the at least one optical fiber including a front end, the method comprising processing the front end of each of the at least one optical fiber before incorporating the at least one optical fiber as part of the flexible optical circuit device.

According to another aspect of the disclosure, a configuration of multiple individual fibers is routed on a flexible substrate to a multi-fiber configuration, such as a ribbon cable.

According to another aspect of the disclosure, a first single fiber is routed on a flexible substrate to a second single fiber.

According to another aspect of the disclosure, a first configuration of multiple fibers is routed on a flexible substrate to a second configuration of multiple fibers that can be different from the first configuration, e.g., the fibers from two ribbon cables can be routed on the flexible substrate to three ribbon cables.

According to another aspect of the disclosure, a method includes routing one or more pre-processed fibers pre-terminated in ferrules that optionally have been pre-assembled in connector bodies on a flexible planar substrate to a fiber cable, the flexible planar substrate rigidly supporting the one or more optical fibers. In other examples, the ferrules can be assembled in connector bodies after the optical fiber have been routed on the substrate.

According to another aspect of the disclosure, the optical fibers include first and second optical fiber segments spliced together. In some examples, the optical fiber segments are mechanically spliced; in other examples, the optical fiber segments are fusion spliced. In some examples, splicing is performed after the second optical segments are routed on the flexible substrate; in other examples, splicing is performed before the second optical segments are routed on the flexible substrate. In some examples, the routing of the second fiber segments is performed after the splicing and after the front ends of the optical fibers have been processed.

According to another aspect of the disclosure, the routing on the substrate is performed using robotics.

According to another aspect of the disclosure, after the routing, the optical fibers or optical fiber segments are secured to the substrate. In some examples, the securing is performed with adhesive.

According to another aspect of the disclosure, the optical fibers include stub portions that extend rearwardly from pre-processed ferrules, and the stub portions are routed on and secured to the substrate after the front ends of the optical fibers have been processed.

According to another aspect of the disclosure, a method includes routing one or more fibers from one or more pre-processed ferrules on a flexible substrate to a fiber cable, the flexible substrate rigidly supporting the one or more optical fibers, the method further including a splicing operation that takes place outside of the ferrules and off of the flexible substrate.

According to another aspect of the disclosure, a method includes routing one or more fibers having pre-processed ends pre-terminated in ferrules on a flexible substrate to a fiber cable, the flexible substrate rigidly supporting the one or more optical fibers, the method further including a splicing operation to create a splice that is not supported on the flexible substrate.

According to another aspect of the present disclosure, a flexible optical circuit includes: a flexible substrate supporting a plurality of optical fibers; and a plurality of optical connectors terminating the optical fibers, wherein the optical fibers are processed and terminated in the optical connectors before the flexible substrate is introduced to the optical circuit to support the plurality of optical fibers.

According to another aspect of the present disclosure, a flexible optical circuit includes: a flexible substrate supporting a plurality of optical fibers; and a plurality of optical connectors terminating the optical fibers, wherein the optical fibers are terminated in the optical connectors before the flexible substrate is introduced to the optical circuit to support the plurality of optical fibers, wherein each of the connectors is secured in a fiber optic adapter of a fiber optic adapter module, wherein a front of one of the fiber optic adapters defines a front plane of the fiber optic adapter module, and wherein an end of at least one of the fiber optic adapters is disposed rearward of the front plane of the fiber optic adapter module.

According to another aspect of the present disclosure, a flexible optical circuit includes a flexible planar substrate, and a plurality of ferrules supported by the substrate, wherein each the ferrules has a face and terminates an optical fiber defining a fiber axis of the ferrule, wherein the faces of the ferrules are positioned relative to the flexible substrate such that a line that intersects the fiber axes of the ferrules and is perpendicular to the fiber axis of each of the ferrules coincides with at least one, but fewer than all, of the faces of the ferrules.

According to another aspect of the present disclosure, a flexible optical circuit includes a flexible substrate, and a plurality of pre-processed ferrules supported by the substrate.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a schematic drawing of a portion of an example flexible optical circuit in accordance with the present disclosure.

FIG. 2 is a partial top, rear, perspective view of a flexible optical circuit and a fiber routing machine in accordance with the present disclosure.

FIG. 3 is a partial top, front, perspective view of a further example of a flexible circuit in accordance with the present disclosure.

FIG. 4 illustrates a sectional view of an example ferrule assembly that can be used in conjunction with a flexible circuit in accordance with the principles of the present disclosure.

FIG. 5 is a rear end view of the ferrule assembly of FIG. 4.

FIG. 6 is a sectional view of an example fiber optic cable and connector assembly that can be used in conjunction with a flexible circuit in accordance with the principles of the present disclosure.

FIG. 7 shows an example partial sequence for splicing in accordance with a flexible circuit of the present disclosure.

FIG. 8 shows an example of a further partial sequence for splicing in accordance with a flexible circuit of the present disclosure.

FIG. 9 is a perspective view of an example adapter module that can be used in conjunction with a flexible circuit in accordance with the present disclosure.

FIG. 10 is a flowchart showing an example method of providing a flexible optical circuit in accordance with the present disclosure.

FIG. 11 depicts an embodiment of a flexible substrate that can be used with a flexible optical circuit in accordance with the present disclosure.

FIG. 12 is a perspective view of an example splicing device that can be used for splicing fibers in accordance with the present disclosure.

FIG. 13 is an end view of the splicing device of FIG. 12.

FIG. 14 is a cross-sectional view of the splicing device of FIG. 12.

FIG. 15 is an exploded view of the splicing device of FIG. 12.

FIG. 16 is a schematic depiction of an example process of providing a flexible optical circuit in accordance with one embodiment of the present disclosure.

FIG. 17 is a schematic depiction of an example process of providing a flexible optical circuit in accordance with a further embodiment of the present disclosure.

FIG. 18 is a schematic depiction of an example process of providing a flexible optical circuit in accordance with yet a further embodiment of the present disclosure.

### DETAILED DESCRIPTION

The present disclosure is directed generally to flexible fiber optic circuits. In certain exemplary applications, the flexible circuits of the present disclosure are designed to relay multiple fibers which terminate at a rear connector, such as an MPO style connector, positioned at a generally rear portion of the circuit, to a plurality of ferrules positioned at a generally front portion of the circuit. In other examples, the flexible circuits of the present disclosure provide fiber routing between individual fiber connectors, fiber routing between multi-fibered connectors, and fiber routing between individual fiber connectors on one side and one or more multi-fiber connectors on the other side. Non-limiting examples of connectors include MPO style connectors, and single or dual fiber connectors, such as LC or SC type connectors.

Flexible optical circuits are passive optical components that comprise one or more (typically, multiple) optical fibers rigidly supported in a flexible planar substrate, such as a Mylar™ or other flexible polymer substrate. Although specific embodiments herein depict and describe planar substrates, it should be appreciated that other substrate configurations, e.g., in which a substrate routes fibers in and/or across multiple planes are also contemplated. Commonly, although not necessarily, one end face of each fiber is disposed adjacent one longitudinal end of the flexible optical circuit substrate and the other end face of each fiber is disposed adjacent the opposite longitudinal end of the flexible optical circuit substrate. The fibers can extend past the end of the flexible substrate so that they can be terminated to optical connectors, which can be coupled to fiber optic cables or other fiber optic components through mating optical connectors.

Supporting the optical fibers on the flexible substrate essentially comprises one or more fibers being routed on the flexible substrate, typically with a needle extending from a robotic arm, and then securing the routed fibers to the flexible substrate with an adhesive, which is allowed to set or cure. In some examples, therefore, the uncured adhesive is pre-applied to the substrate before the fiber routing. Furthermore, in some examples, an additional layer of material can be applied on top of the fibers and the adhesive to affix the fibers. Any suitable material can be used for this purpose. In a non-limiting example, an elastomer such as silicone can be applied on top of the fibers and the adhesive on the substrate. In some examples, the elastomer is cured after application to the substrate; in other examples, the silicone can be pre-cured.

The method of assembly of the flexible optical circuits of the present disclosure provides a number of advantages, which will be discussed in further detail below. For example, by pre-processing the fiber ends before incorporating the fibers into the flexible optical circuit, disadvantages of processing after the flexible circuit is complete can be avoided. For example, it is difficult or impossible to efficiently polish a stepped or staggered configuration of fiber ends for coupling to a correspondingly configured connector or adapter module. In addition, processing fibers and/or ferrules as a group is a cumbersome process requiring specific mechanisms and fixtures to coordinate the simultaneous processing of the multiple fibers or ferrules. Furthermore, when processing groups of fibers or ferrules, if the processing or subsequent testing results in or reveals an inoperable or poorly functioning ferrule/fiber, in some cases the entire group of ferrules/fibers must be scrapped. In contrast, processing of ferrules/fibers individually before integrating them into the flexible optical circuit and/or before integrating all of the fibers into the flexible optical circuit enables the ferrules/fibers to be individually tested following processing, which can help ensure ferrule reliability prior to installation, while reducing waste.

Throughout this disclosure, processing of ferrules and fibers includes any suitable treatment of ferrules or fibers that can be performed to enhance optical transmission, splicing, connectivity, and the like. To ready fiber ends for processing, the fibers are first stripped of their coating layers, and then cleaved. The fiber ends are then cleaned/polished. The cleaning/polishing process is designed to smooth out any imperfections in the fiber face to enhance optical transmission. For fiber stubs having an end supported by a ferrule (as opposed to an unsupported fiber end used for, e.g., splicing to a ferrule-supported fiber stub), processing of the fiber end typically occurs after the fiber end has been terminated at the ferrule, and the ferrule face can polished at the same time. As used herein, a fiber that is terminated at or in a ferrule means that a front end of the fiber is positioned adjacent the front end face of the ferrule. In some examples, processing of the fiber ends includes a mechanical polishing of the fiber ends which can be performed, e.g., with an abrasive slurry and/or abrasive pads. In other examples, cleaning, shaping, re-flowing and other types of processing of the fiber ends is performed by an energy source. Examples of such energy sources include but are not limited to laser treatment, plasma treatment, corona discharge treatment, heat treatment, and electric arc treatment. Different fiber end processing techniques and methods are disclosed in U.S. Patent Application Publication No. 2014/0124140, the contents of which are hereby incorporated by reference in their entirety.

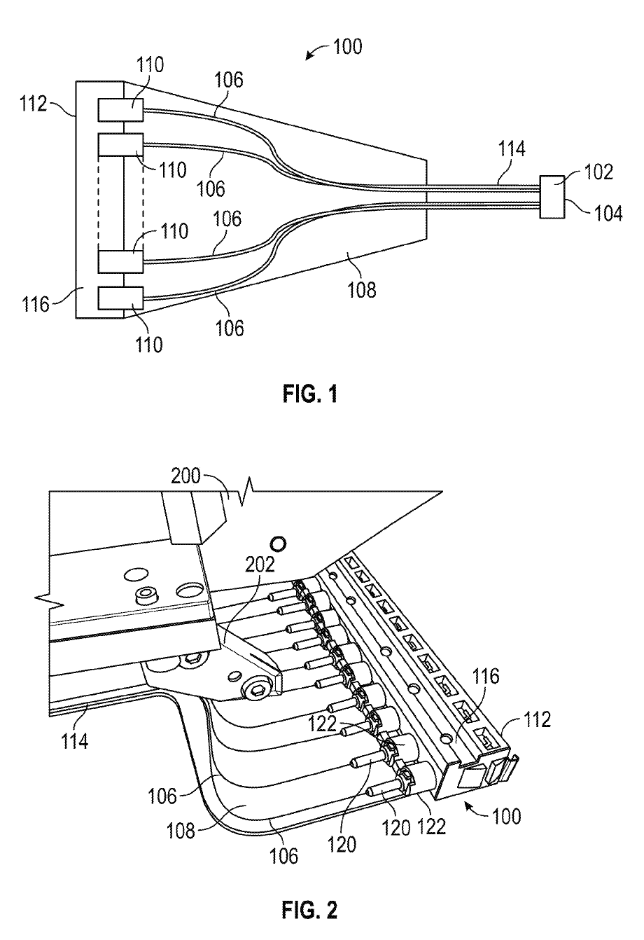

FIG. 1 is a schematic drawing of an example flexible optical circuit 100 in accordance with the present disclosure. The flexible optical circuit 100 includes optical fibers 106 routed on a planar flexible substrate 108 between a rear connector 102 (e.g., an MPO connector) at the rear 104 of the circuit 100 and a plurality of front connectors 110 disposed towards a front end 112 of the circuit 100. In some examples, there are twelve fibers 106 routed from twelve front connectors 110 to a single rear connector 102, the fibers coming together as they approach the rear connector 102 to form a ribbon cable 114, the ribbon cable 114 including twelve individual fibers 106. The front connectors can be conventional connectors (such as an LC or SC connector), or unconventional connectors, that is, connectors that generally have not become a recognizable standard footprint for fiber optic connectivity in the industry.

An adapter module 116 includes a plurality of adapters for mating the front connectors 110 and connecting them to, e.g., other connectors or telecommunications equipment.

In an example method of providing the flexible optical circuit 100 of FIG. 1, front ends of the fibers 106 are pre-processed by one of the processing methods described above. The front ends of the fibers 106 can be individually terminated to ferrules and the ferrules mated to the front connectors 110. Portions of the fibers 106 can be routed on the flexible substrate 108 before or after the fibers are terminated in the ferrules, but the routing of the fibers 106 on the flexible substrate 108 is performed after the fiber ends are processed. Thus, in some examples, ferrules can be individually pre-terminated with fiber ends and the fiber ends processed before the fibers are routed on the flexible substrate 108. The pre-installed connector can be any standard or unconventional connector, including but not limited to LC, SC, FC, MU, and ferrule-less connectors (i.e., connectors that do not support ferrules).

To route the fibers on the substrate 108, in some examples the fiber can be laid on the substrate 108 by being passed through a needle controlled by robotics, the robotics being configured to route each fiber along a predefined path on the substrate 108. The robotics can be configured to route each fiber in a single plane or across multiple planes; similarly, separate fibers can be routed in the same or different plane(s) of the substrate as other fibers. As it routes the optical fibers, the needle can be configured to press the optical fibers onto an adhesive layer that has been pre-applied to the substrate 108. In some examples, the fiber is dispensed from a spool and a cutting device disposed at or near the needle end is configured to cut each length of fiber after it has been laid on the substrate so that the next length of fiber can be laid.

As mentioned, in some examples, the routed fibers are secured to the substrate by adhesive. In some examples, the optical fibers pass through the needle onto an uncured adhesive layer on the substrate 108, and then the adhesive and/or an elastomeric or other fiber fixating material applied to the adhesive is allowed to cure to secure the fibers to the substrate 108. The paths and lengths of the individually routed fibers on the substrate can vary from fiber to fiber.

FIG. 2 is a partial perspective view of a flexible circuit 100 and a fiber routing machine 200. The flexible circuit 100 having front end 112 includes the optical fibers 106 routed to a ribbon cable 114 on a flexible substrate 108, as described above, the ribbon cable 114 being a tightly stacked set of twelve individual fibers 106. In addition, in this example front ends of the fibers 106 are terminated in ferrules 120 mated with adapters 122 in an adapter module 116, and the front ends of the fibers 106 are processed before the fibers are routed on the substrate 108. The fiber routing machine 200 includes robotics that move a needle to route the portions of the fibers 106 extending from the rear of the ferrules 120 onto the flexible substrate 108 to form the ribbon cable 114 towards the rear of the flexible circuit 100. The robotics can include one or more systems, (e.g., linear motion systems including one or more drivers) configured to move one or more components of the fiber routing machine to perform the desired fiber routing. For example, the robotics can include a robotic arm 202, and the machinery, controllers and power source needed to move the robotic arm 202 to effect the desired routing of the fibers 106 on the flexible substrate 108. The needle of the fiber routing machine 200 extends from the robotic arm 202 and lays the fibers.

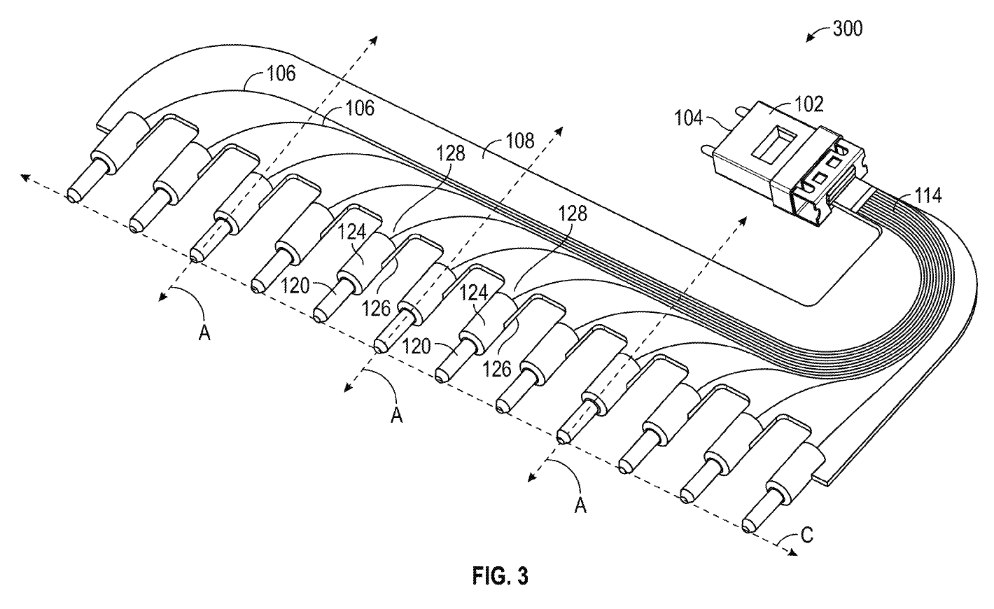

FIG. 3 is a partial perspective view of a further example of a flexible circuit 300, including a rear (MPO) connector 102, a rear end 104, optical fibers 106 with pre-processed ends routed on a flexible substrate 108, ferrules 120, the routed fibers 106 forming a ribbon cable 114 before connecting to the rear connector 102 as discussed above. In this example, the front faces of the ferrules 120 are also processed (e.g., polished) before the ferrules 120 are connected to the substrate 108. In this example, the ferrules 120 include ferrule hubs 124. Each ferrule hub 124 defines a notch or cutout 126 for receiving front portions of front extensions 128 of the flexible substrate 108. The row of ferrules 120 can be mated with connectors as discussed above.

Structural modifications to the examples of flexible circuits shown in FIGS. 1-3, including structural differences in flexible substrate, fiber routing, ribbonization of the fibers, connectorization of the fibers, front connectors, rear connectors, adapters, adapter modules, and the inclusion of fiber optic cassettes or other holders to hold the flexible circuits of FIGS. 1-3 to facilitate the circuits' use with telecommunications equipment may be contemplated in accordance with the disclosures of U.S. Patent Application Publication No. 2015/0253514, the contents of which are hereby incorporated by reference in their entirety.

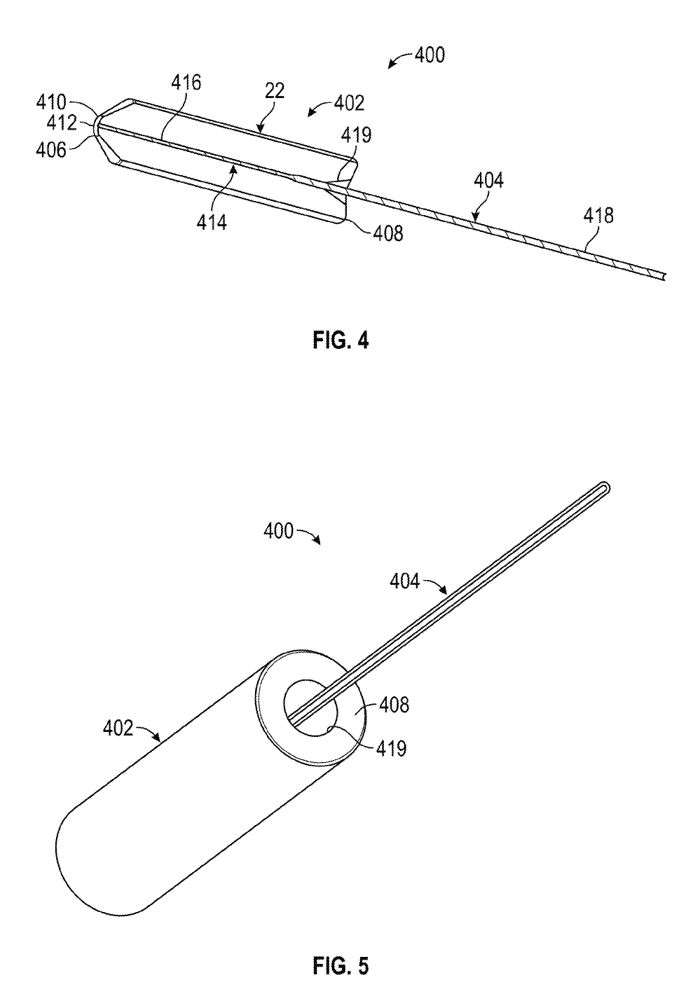

FIG. 4 illustrates a sectional view of a ferrule assembly 400 that can be used in conjunction with the flexible circuit in accordance with the principles of the present disclosure. FIG. 5 is a rear end view of the ferrule assembly 400 of FIG. 4. Referring to FIGS. 4-5, the ferrule assembly 400 includes a ferrule 402 and a first optical fiber segment 404 secured to the ferrule 402. The ferrule 402 includes a front end 406 positioned opposite from a rear end 408. The front end 406 preferably includes an end face 410 at which a processed end 412 of the first optical fiber segment 404 is located, i.e., adjacent to. The ferrule 402 defines a ferrule bore 414 that extends through the ferrule 402 from the front end 406 to the rear end 408. The first optical fiber segment 404 includes a first portion 416 secured within the ferrule bore 414 and a second portion 418 (or stub) that extends rearwardly from the rear end 408 of the ferrule 402. The ferrule bore 414 can include a conical transition 419.

The ferrule 402 is preferably constructed of a relatively hard material capable of protecting and supporting the first portion 416 of the first optical fiber segment 404. In one embodiment, the ferrule 402 has a ceramic construction. In other embodiments, the ferrule 402 can be made of alternative materials such as Ultem, thermoplastic materials such as Polyphenylene sulfide (PPS), other engineering plastics or various metals.

The first portion 416 of the first optical fiber segment 404 is preferably secured by an adhesive (e.g., epoxy) within the ferrule bore 414 of the ferrule 402.

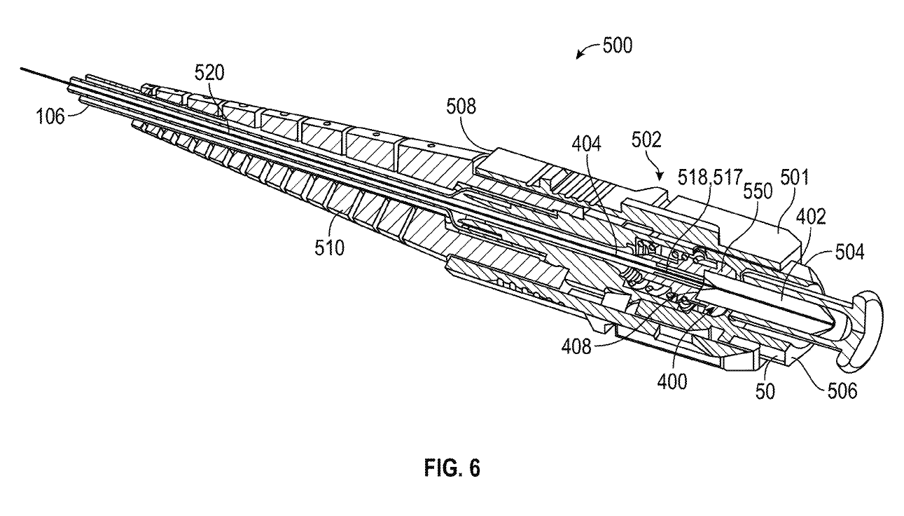

FIG. 6 is a sectional view of an optical fiber 106 as described above, and a connector assembly 500 that can be used in conjunction with a flexible circuit in accordance with the principles of the present disclosure. The connector assembly 500 can include a front connector 110 as described above. In the specific example shown in FIG. 6, the connector assembly 500 includes a fiber optic connector 502 having a connector body 504. The connector body 504 has a front end 506 and a back end 508. A release sleeve 501 is positioned over the connector body 504. The release sleeve 501 can be pulled back relative to the connector body 504 to release the connector from an adapter port. The ferrule assembly 400 described above is positioned at least partially within the connector body 504. Specifically, the ferrule assembly 400 is positioned with the ferrule 402 positioned adjacent to the front end 506 of the connector body 504. The fiber optic connector 502 further includes a boot 510 mounted adjacent the back end 508 of the connector body 504. As used herein, the word “adjacent” means at or near and includes situations where the optical fiber protrudes beyond the end face of the ferrule. In some examples, the connector 502 is compatible with existing connectors, fiber optic adapters, patch panels and fiber optic cables.

The fiber optic cable and connector assembly 500 further includes the optical fiber 106 that extends through the boot 510. The optical fiber 106 includes the first optical fiber segment 404 discussed above and a second optical fiber segment 520. The first optical fiber segment 404 and the second optical fiber segment 520 are optically connected to each other at a splice 517 (e.g., a fusion splice or a mechanical splice). The splice 517 is positioned at a splice location 518, at the rear end of the second portion 418 of the first optical fiber segment 404 and the front of the second optical fiber segment 520, spaced from the rear end 408 (i.e., the base) of the ferrule 402. In the example shown, the splice location 518 is within the connector body 504. In some examples, the splice 517 is a factory fusion splice. A “factory fusion splice” is a splice performed at a manufacturing facility as part of a manufacturing process. In other examples, the splice can be a field splice.

In accordance with the embodiments of the present disclosure, at least the front end of the first optical fiber segment 404 is processed before (i.e., pre-processed) the second optical fiber segment 520 (which extends rearward beyond the connector assembly 500) is routed on a flexible substrate of a flexible circuit. In accordance with embodiments of the present disclosure, the splice 517 can be performed before or after the second optical fiber segment is routed on a flexible substrate of a flexible circuit.

It will be appreciated that different connector assembly styles and arrangements can be used. In certain examples, simplified versions of the connector can be used where various components of the connector can be eliminated (e.g., the boot, the outer release sleeve, etc.)

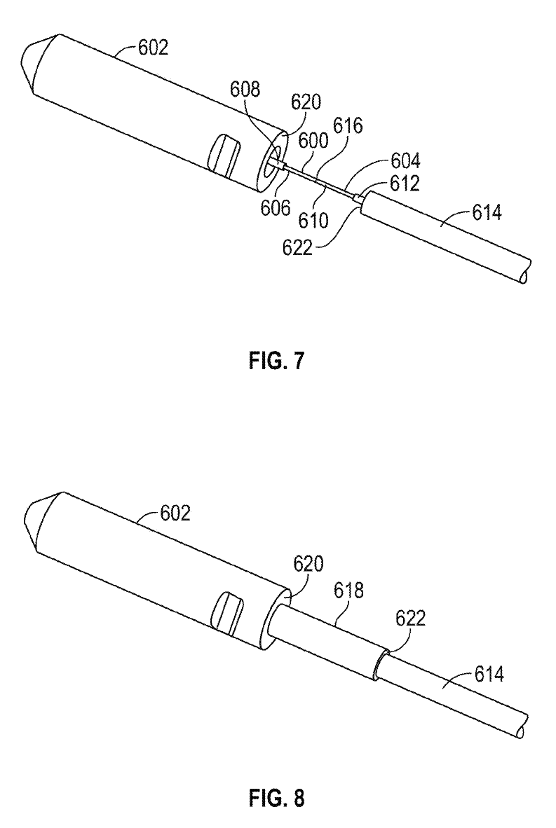

FIGS. 7-8 show an example partial sequence for splicing in accordance with a flexible circuit of the present disclosure. The following splicing sequence could be applied, e.g., to any of the fibers 106 described above, and could be performed before or after the optical fibers are routed on the flexible substrate of the flexible circuit. Thus, in some examples, the fibers 106 described above can include both the first optical fiber segment 600 and the second optical fiber segment 604 as described below. In some examples the splice is supported on the flexible substrate 108, that is, the portion of the fiber or fibers 106 containing the splice is secured on the flexible substrate. In other examples, the splice is not supported on the flexible substrate 108; that is, the splice could be positioned, e.g., forward of a forward edge or rearward of a rearward edge of the flexible substrate 108. Typically, when the splice is positioned forward of the flexible substrate, the splice is performed between a relatively short first optical fiber segment 600 and a relatively long second optical fiber segment 604. This example is described in more detail below.

As shown in FIGS. 7-8, a pre-processed first optical fiber segment 600 is terminated at a ferrule 602 and spliced to a second optical fiber segment 604 of a fiber optic cable. The pre-processed first optical fiber segment 600 includes a bare fiber portion 606 and a coated fiber portion 608. The second optical fiber segment 604 optionally includes a bare fiber portion 610 and a coated fiber portion 612. Portions or the entirety of one or both of the bare fiber portion 610 and the coated fiber portion 612 can be routed on a flexible substrate. The fiber optic cable may optionally also include a buffer tube 614 that surrounds the coated portion 612 of the second optical fiber segment 604. The second optical fiber segment 604 is coaxially aligned with the pre-processed first optical fiber segment 600 in preparation for splicing, and then spliced at the splice location 616. In this example splicing procedure, an optional protective layer 618 (FIG. 8) is over molded or otherwise applied over the splice location 616 (FIG. 7) between the second optical fiber segment 604 and the bare fiber portion 606 of the first optical fiber segment 600. The protective layer 618 extends from a rearward end 620 of the ferrule 602 to a forward end 622 of the buffer tube 614.

Following the splicing procedure, in some examples, a ferrule hub 550 (FIG. 6) is optionally secured over the rear end 620 of the ferrule 602. In some examples, as shown in FIG. 6, the hub 550 also covers the splice location (518, 616) such that the splice 517 is located within the hub 550. In certain embodiments, the hub 550 has a polymeric construction that has been over molded over the rear end 620 of the ferrule 602 and over the splice location (518, 616). By protecting the fusion splice 517 within the hub 550 at a location in close proximity to the ferrule 602, it is possible to manufacture a fiber optic connector that is relatively short in length.

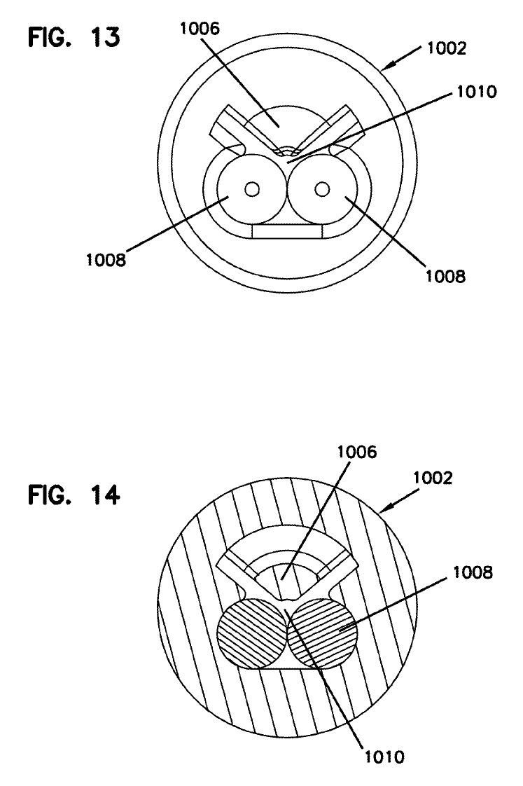

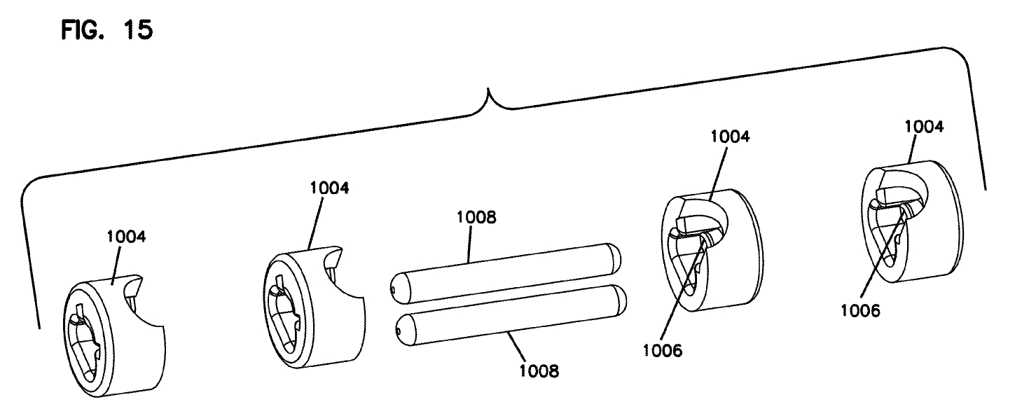

FIGS. 12-15 show an example mechanical splicing device 1000 that can be used to perform an alternative mechanical splicing procedure that can be used to splice ends of first and second fiber segments (e.g., the fiber segments 600 and 604 in FIG. 7) in accordance with the principles of the present disclosure. The mechanical splicing device 1000 includes a splice housing 1002 formed by a plurality of housing segments 1004 that are connected end-to-end. Each of the housing segments 1004 includes at least one flexible cantilever arm 1006 having a base end that is unitarily formed with a main body of its corresponding housing segment 1004. Alignment rods 1008 are mounted within the splice housing 1002. The alignment rods 1008 define a fiber alignment groove 1010 in which the optical fiber segments (e.g., optical fiber segments 600 and 604) are received to co-axially with each other to form the optical fiber 106. Free ends of the cantilever arms 1006 are adapted to press the optical fibers into the fiber alignment groove 1010. The splice housing 1002 can also be filled with adhesive for encapsulating the optical fiber segments to anchor the fiber ends within the housing 1002.

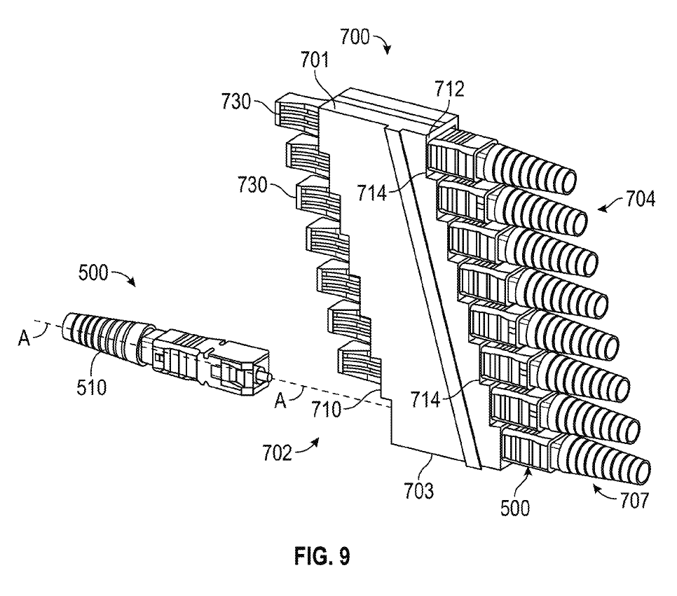

FIG. 9 is a perspective view of an example adapter module 700 that can be used in conjunction with a flexible circuit as disclosed herein. The adapter module 700 can be removably mountable for connection with telecommunications equipment. Thus, in some examples, the adapter module 700 is removably mountable to a wall or chassis in proximity to telecommunications equipment.

The adapter module 700, having a top 701 and a bottom 703, can be the adapter module 116 of FIG. 1. The adapter module 700 has a front 702 and a back 704. The front 702 can correspond to the front 112 of the flexible circuit of FIG. 1. A first series 707 of connector assemblies 500 are insertable and removable from the rear 704 into the rear receptacles of adapters housed in the adapter module 700. In this example, the first series 707 of connectors includes up to eight connectors, as the adapter module 700 houses eight adapters. The first series of connector assemblies 500 can correspond to the front connectors 110 of FIG. 1. It can be contemplated how the adapter module 700 can house more or fewer adapters and thereby accommodate more or fewer connector assemblies 500. The first series 707 of connector assemblies are adapted to optionally couple with a second series of fiber optic connectors 500 inserted into adapter ports at the front 702 of the adapter module. The connector assemblies are inserted and removed axially into the adapter ports, i.e., along a longitudinal ferrule fiber axis A. Dust plugs 730 that protect the adapters housed within the adapter module 700 can be removed prior to installing the connector assemblies 500.

The adapter module includes forward and rearward receptacles (e.g., adapter ports) for receiving the fiber optic connectors. The forward receptacles and rearward receptacles of the adapters are positioned relative to each other such that the front face of the ferrule of a connector of the first series of connectors that is installed in the rearward receptacle is optically coupled to the corresponding front face of the ferrule of a connector of the second series of connectors that is installed in the forward receptacle of the adapter.

As shown in FIG. 9, the example adapter module 700 has a stepped configuration. Each of the front 702 and the back 704 of the adapter module 700 has a stepped facade. The stepped facade 710 of the front 702 faces forwards, while the stepped facade 712 on the rear 704 faces rearwards. Due to the stepped nature of the facades (710, 712), the axial distance by which a first installed connector of the first series of connectors extends rearwardly relative to its own respective step 714 of the stepped facade 712 differs from the axial distance by which that first installed connector of the first series of connectors extends rearwardly relative to another step of the 714 stepped facade 712. Likewise, the axial distance by which a first installed connector of the second series 706 of connectors extends forwardly relative to its own respective step 714 of the stepped facade 710 differs from the axial distance by which that first installed connector of the first series of connectors extends forwardly relative to another step 714 of the stepped facade 710. With this definition of “stepped,” numerous other configurations can be contemplated beyond the example shown in FIG. 9 of stepped adapter modules in which a line that is perpendicular to the fiber axes and with which all of the fiber axes intersect, coincides with the back end 709 of at least a first connector but does not coincide with the back end 709 of at least a second connector in the same series of connectors as the first connector. An example adapter module of this type can be found at PCT Publication No. WO2010/059623 which is hereby incorporated by reference.

Referring again to FIG. 3, if the flexible substrate 108 were modified so that the ferrules 120 could be installed in a series of connectors compatible with an adapter module having a stepped configuration (e.g., the adapter module 700 of FIG. 9), the free ends of the ferrules 120 would not align as they do in FIG. 3 along the line C that is perpendicular fiber axes and intersects each of the ends of the ferrules 120. Thus, were the flexible substrate 108 in FIG. 3 modified for a stepped adapter module, it would be difficult or impossible to process the front ends of the optical fibers once the fibers were routed on the flexible substrate 108. Thus, to overcome this problem, in accordance with the present disclosure ferrule faces and their respective fiber ends are processed before routing the fibers on the flexible substrate of the flexible circuit.

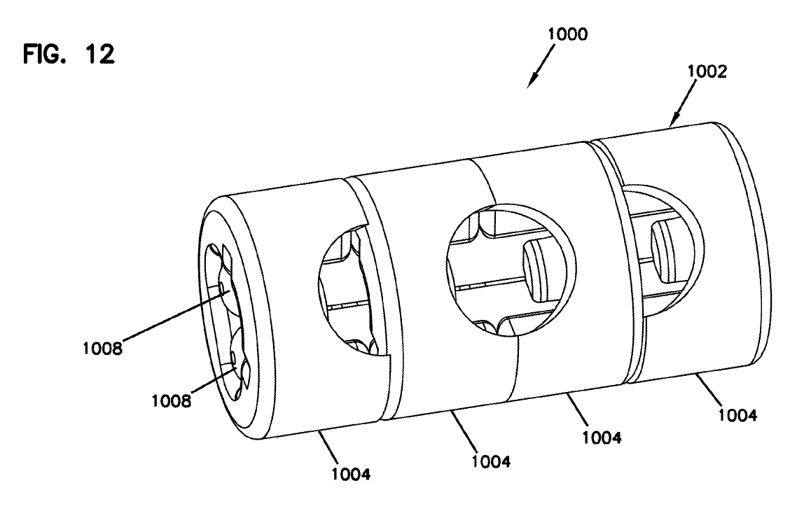

An example of such a modified flexible substrate 900 in accordance with the present disclosure is illustrated in FIG. 11. The flexible substrate 900 includes a front 902 and a back 904 and front extension 906. In this example, the flexible substrate 900 includes eight front extensions 906, but it should be appreciated that more or fewer front extensions can be provided. The flexible substrate 900 can be used, for example, to route fibers from the first or second series of connector assemblies 500 housed in the adapter module 700 of FIG. 9. Referring again to FIG. 11, each of the front extensions 906 is configured to support a ferrule as described above in connection with FIG. 3. Each of the front extensions 906 has a front end 908, the front extension 906 extending forwardly from a main portion 907 of the flexible substrate 900. Fibers terminated at the ferrules can be routed on the flexible substrate 900 into a ribbon cable in the narrowed region 910 of the flexible substrate 900, as discussed above. Although ferrules are not shown in FIG. 11, the fiber axes A₁-A₈ of such ferrules are depicted. The front extensions 906 are in a stepped configuration. More specifically, as shown in FIG. 11, a line, such as a line D₁ or a line D₂, which intersects the fiber axes A₁-A₈ and is perpendicular to the fiber axes A₁-A₈ coincides (e.g., at points P₁ or P₂) with the front end 908 of at least one, but fewer than all, of the of the front extensions 906.

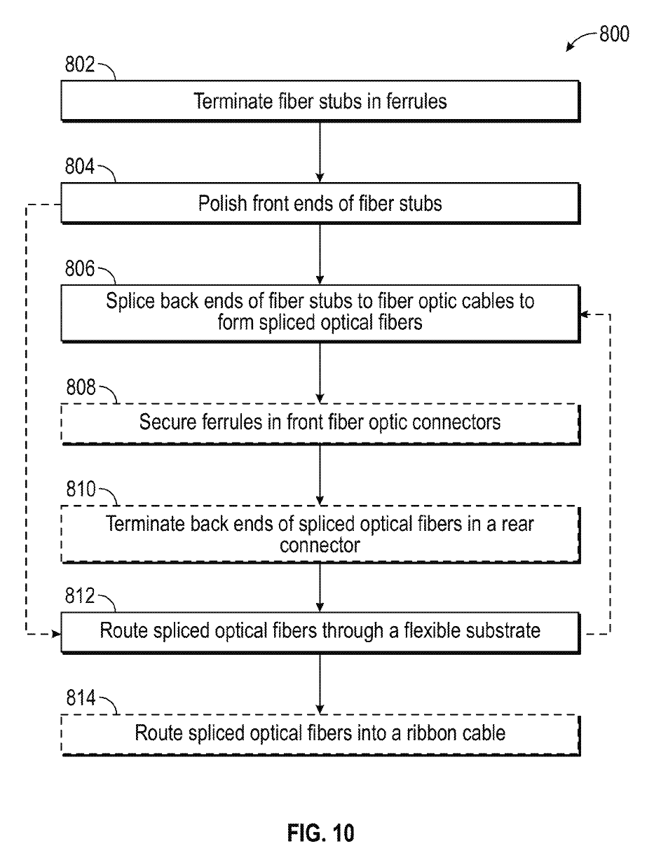

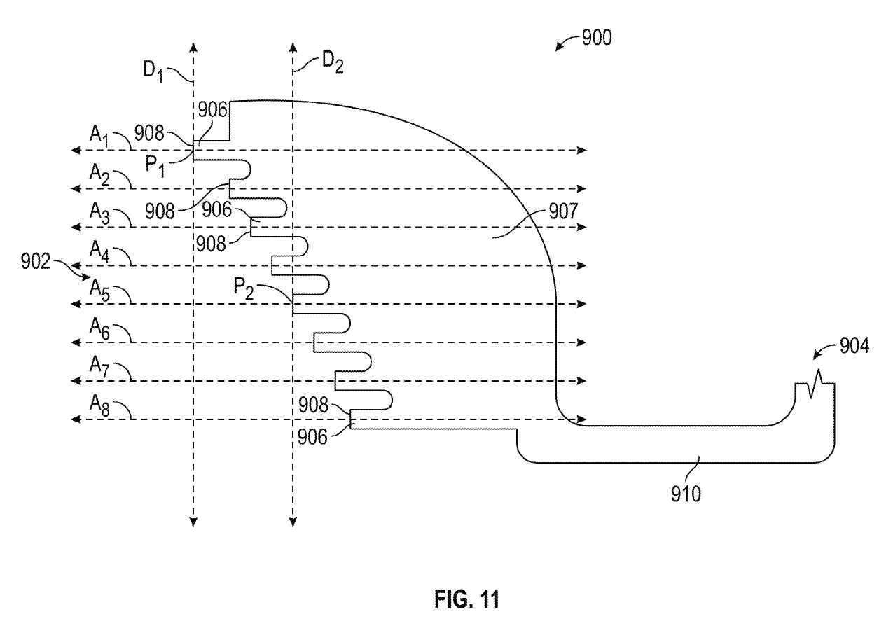

FIG. 10 is a flowchart showing an example method 800 of providing a flexible optical circuit in accordance with the present disclosure, the flexible optical circuit having a front end and a rear end. It should be appreciated that the enumerated steps of the method 800 can be performed in any suitable order except where otherwise indicated.

In a step 802, each of a plurality of a fiber ends is processed, e.g., polished mechanically or using an energy source.

In a step 804, each of the plurality of fibers is terminated in one of the ferrules, each of the ferrules having a front face configured to optically connect the pre-processed front end of the fiber to another optical fiber segment.

In an optional step 806, one or more of the fibers is spliced to form spliced optical fibers.

In an optional step 808, one or more of the ferrules are secured in front fiber optic connectors of the flexible optical circuit.

In an optional step 810, back ends of one or more of the spliced optical fibers are terminated in at least one rear connector of the flexible optical circuit.

In a step 812 that is subsequent at least to the step 802, and subsequent to or preceding the step 804 and subsequent to or preceding one or both of optional steps 806 and 808, at least a portion of each of the spliced optical fibers is routed on a flexible substrate.

In an optional step 814, the routing of step 812 includes routing the fibers or spliced optical fibers into a ribbon cable.

In some examples, the spliced optical fibers are terminated in the rear connector as a ribbon cable.

In some examples, the step 806 is performed before the step 812, and splices formed during the step 806 are supported on the flexible substrate. In other examples, splices formed during the step 806 are not supported on the flexible substrate. In some examples, the back ends of the fibers terminated at the ferrules do not reach a front end of the flexible substrate. In other examples the back ends of the fibers terminated at the ferrules are supported on the flexible substrate. In some examples the back ends of the fibers terminated at the ferrules are positioned beyond a back end of the flexible substrate. In some examples, the front faces of the ferrules are positioned such that a line that intersects a fiber axis of each of the ferrules and is perpendicular to the fiber axis of each of the ferrules coincides with at least one, but fewer than all, of the front faces of the ferrules.

In certain examples, splicing can be eliminated and an un-spliced stub fiber from the ferrule can be routed on the substrate after the end of the fiber has been processed.

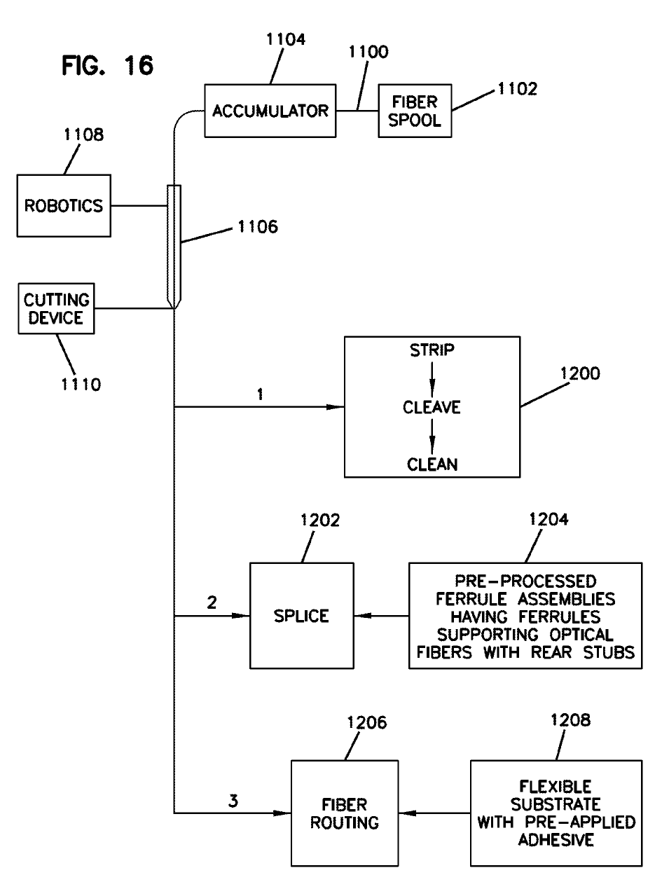

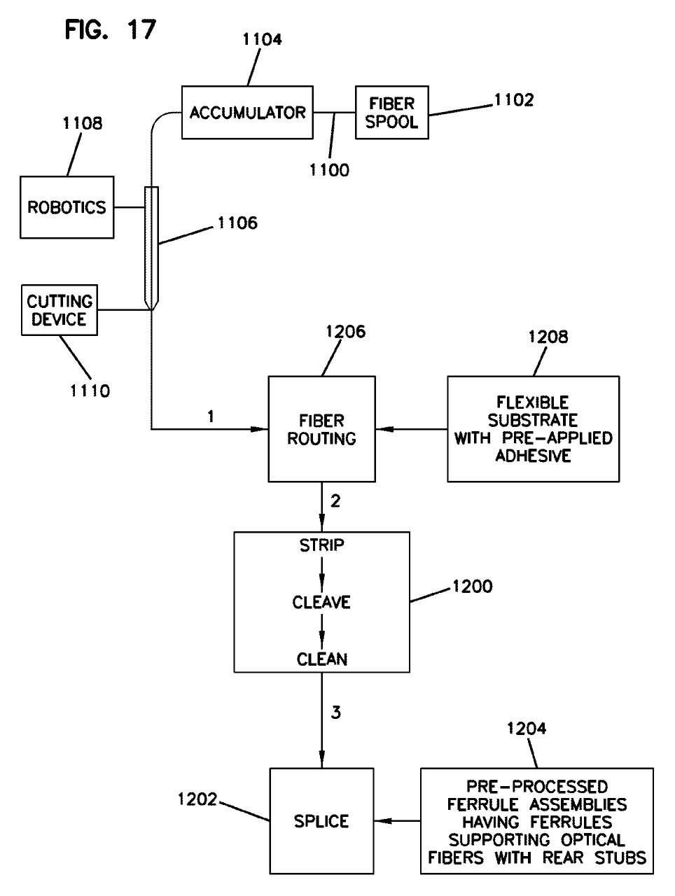

FIG. 16 is a schematic depiction of an example process of providing a flexible optical circuit in accordance with one embodiment of the present disclosure. According to the embodiment of FIG. 16, optical fiber 1100 is dispensed from a spool 1102 and passes through an accumulator 1104, which enables fiber to be dispensed and routed without continuously turning the spool 1102. The fiber 1100 passes through a needle 1106. The needle 1106 moves via robotics 1108.

A front end of a first length of the fiber 1100 is processed by a processing device 1200 that strips one or more outer layers from the fiber, cleaves the exposed bare fiber, and cleans/polishes the end face of the exposed bare fiber.

Subsequent to the stripping, cleaving and stripping, a stripped, cleaved and cleaned front fiber end is introduced to a splicing device 1202, such as a mechanical splicing device or a fusion splicing device. In this embodiment, the splicing device 1202 splices the stripped, cleaved and cleaned front fiber end (i.e., the front of a first fiber segment) to the rear end of a fiber stub (i.e., a second fiber segment) extending from a pre-processed ferrule assembly 1204 (which includes a ferrule whose fiber stub end adjacent the ferrule face has been polished or otherwise processed).

Subsequent to the splicing, the needle 1106 performs a fiber routing operation 1206 along a predefined (e.g., pre-programmed) path on a flexible substrate 1208 having a pre-applied adhesive thereon. When the routing of the first fiber length is complete, the cutting device 1110 severs the routed fiber creating a back end to the first length of fiber and a new front end for a subsequent second length of fiber, and the process starts over to process and route the second length of fiber. It should be appreciated that this process can be repeated many times on a single flexible substrate and/or on multiple flexible substrates.

FIG. 17 is a schematic depiction of an example process of providing a flexible optical circuit in accordance with a further embodiment of the present disclosure. According to the embodiment of FIG. 17, optical fiber 1100 is dispensed from a spool 1102 and passes through an accumulator 1104, which enables fiber to be dispensed and routed without continuously turning the spool 1102. The fiber 1100 passes through a needle 1106. The needle 1106 moves via robotics 1108.

Unlike the embodiment in FIG. 16, in FIG. 17, the needle 1106 first performs the fiber routing 1206 of a first fiber length along a predefined (e.g., pre-programmed) path on a flexible substrate 1208 having a pre-applied adhesive thereon. When the routing of the first fiber length is complete, the cutting device 1110 severs the routed fiber creating a back end to the first length of fiber and a new front end for a subsequent second length of fiber. At this point, the back end and/or the front end of the first length of fiber 1100 is processed by a processing device 1200 that strips one or more outer layers from the fiber, cleaves the exposed bare fiber, and cleans/polishes the end face of the exposed bare fiber. At this point, the stripped, cleaved and cleaned front and/or back fiber end is introduced to a splicing device 1202, such as a mechanical splicing device or a fusion splicing device. The splicing device 1202 splices the stripped, cleaved and cleaned front and/or back fiber end to the opposite end of a fiber stub extending from a pre-processed ferrule assembly 1204 (that includes a ferrule whose fiber stub end adjacent the ferrule face has been polished or otherwise processed). The same process can be performed for each of any number of subsequent fiber lengths. In some examples, the routing of a subsequent fiber length is performed while a prior fiber length is being processed and/or spliced.

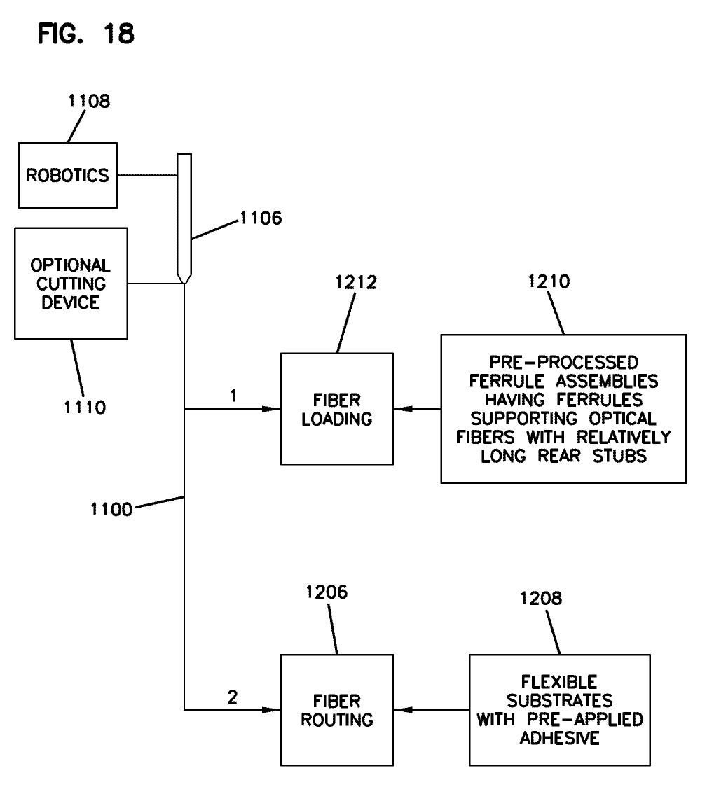

FIG. 18 is a schematic depiction of an example process of providing a flexible optical circuit in accordance with yet a further embodiment of the present disclosure. In this example, in a loading operation 1212 (which can be performed, e.g., by a loading device), a pre-processed ferrule assembly 1210 is loaded into the needle 1106 which is moved by the robotics 1108. The pre-processed ferrule assembly 1210 includes a ferrule supporting a fiber stub. The front end of the fiber stub is positioned adjacent the ferrule face, and has been polished or otherwise processed prior to the loading operation. In one example, the loading operation can include a vacuum system that draws a fiber stub into the needle. In this example, the fiber stub is relatively long. The fiber stub can be pre-cut or optionally cut by the cutting device 1110 to form a rear end of the fiber stub. In the routing operation 1206, which is performed after the loading operation 1212, the relatively long fiber stub is long enough to be routed by the needle 1106 on the flexible substrate 1208 having pre-applied adhesive without the need for a splice. That is, the fiber stub that is supported in the pre-processed ferrule assembly is long enough to achieve a complete single fiber routing on the flexible substrate without a splice. After the first relatively long fiber stub is routed, the process depicted in FIG. 18 can be repeated for subsequent fiber routings on the same or different flexible substrates 1208.

In certain examples, the fiber stubs can all have a pre-defined length that is as long as or longer than the longest fiber routing path needed for the flexible circuit. For this example, the fiber stubs can be cut to length by the cutting device. In other examples, the fiber stubs can be pre-cut to different lengths corresponding to different fiber routing path lengths. For this example, a fiber stub having a length equal to the desired fiber routing path would be selected and loaded into the needle thereby eliminating the need for subsequent cutting.

According to a first embodiment of the present disclosure is provided a flexible optical circuit comprising: a flexible substrate; a plurality of optical fibers; and a plurality of ferrules supported on the substrate, each of the ferrules comprising a face and terminating a first end of one of the plurality of optical fibers, each of the plurality of optical fibers defining a fiber axis of one of the plurality of ferrules, the faces of the ferrules being positioned relative to the flexible substrate such that a first line that intersects each of the fiber axes of the ferrules and is perpendicular to each of the fiber axes of the ferrules coincides with at least one, but fewer than all, of the faces of the ferrules.

According to a second embodiment is provided a flexible optical circuit as in the first embodiment, wherein the line coincides with only one of the faces of the ferrules.

According to a third embodiment is provided a flexible optical circuit as in the first embodiment, wherein the flexible substrate comprises a plurality of extensions; and wherein each of the extensions has an end, and wherein a second line that intersects each of the fiber axes of the ferrules and is perpendicular to each of the fiber axes of the ferrules coincides with at least one, but fewer than all, of the ends of the extensions.

According to a fourth embodiment is provided a flexible optical circuit as in the first embodiment, wherein the plurality of optical fibers are routed on the flexible substrate.

According to a fifth embodiment is provided the flexible optical circuit of the fourth embodiment, wherein the plurality of optical fibers are routed into a ribbon cable.

According to a sixth embodiment is provided the flexible optical circuit of the fifth embodiment, wherein each of the optical fibers comprises a splice supported on the flexible substrate.

According to a seventh embodiment is provided the flexible optical circuit of the fifth embodiment, wherein each of the optical fibers comprises a splice not supported by the flexible substrate.

According to an eighth embodiment is provided the flexible optical circuit of the first embodiment, wherein each of the ferrules is housed in one of a plurality of fiber optic connectors, and wherein the fiber optic connectors are removably installable in a fiber optic adapter module.

According to a ninth embodiment is provided the flexible optical circuit of the eighth embodiment, wherein the fiber optic adapter module comprises a facade, the facade having a stepped configuration.

According to a tenth embodiment is provided the flexible optical circuit of the ninth embodiment, wherein each of the fiber optic connectors has an end, and wherein the installed fiber optic connectors are positioned relative to one another in the adapter module such that a second line that intersects each of the fiber axes of the ferrules and is perpendicular to each of the fiber axes of the ferrules coincides with at least one, but fewer than all, of the ends of the fiber optic connectors.

According to an eleventh embodiment is provided a flexible optical circuit comprising: a flexible substrate, the flexible substrate comprising a plurality of parallel extensions, each of the extensions extending along an axis from a main portion of the flexible substrate to an end, wherein a line that intersects each of the axes of the extensions is perpendicular to each of the axes, and coincides with at least one, but fewer than all, of the ends of the extensions.

According to a twelfth embodiment is provided the flexible optical circuit of the eleventh embodiment, wherein the line coincides with only one of the ends of the extensions.

According to a thirteenth embodiment is provided the flexible optical circuit of eleventh embodiment, wherein a plurality of optical fibers are routed on the flexible substrate.

According to a fourteenth embodiment is provided the flexible optical circuit of claim eleventh embodiment, wherein each of the extensions supports a fiber optic ferrule.

Although in the foregoing description, terms such as “top,” “bottom,” “front,” and “back”/“rear” were used for ease of description and illustration, no restriction is intended by such use of the terms. The flexible optical circuits described herein can be used in any orientation, depending upon the desired application.

Having described the preferred aspects and embodiments of the present disclosure, modifications and equivalents of the disclosed concepts may readily occur to one skilled in the art. However, it is intended that such modifications and equivalents be included within the scope of the claims which are appended hereto.

1. A method of making a flexible optical circuit device, the flexible optical circuit device including a flexible planar substrate supporting a plurality of optical fibers secured to the flexible planar substrate, the flexible optical circuit device also including ferrules in which the optical fibers are secured, the ferrules including front end faces and the optical fibers including front ends positioned adjacent to the front end faces, the method comprising:
processing the front ends of the optical fibers before the ferrules are incorporated as part of the flexible optical circuit device and after the optical fibers have been secured within the ferrules.

2. The method of claim 1, wherein the front ends of the optical fibers are processed by a mechanical polishing.

3. The method of claim 1, wherein the front ends of the optical fibers are processed by application of an energy source to the first ends of the optical fibers.

4. The method of claim 3, wherein the energy source includes a laser or a plasma.

5. The method as in claim 1, wherein the optical fibers each include first and second optical fiber segments spliced together.

6. The method of claim 5, wherein the first and second optical fiber segments are fusion spliced together or mechanically spliced together.

7. The method of claim 5, wherein the first optical fiber segments are secured in the ferrules and define the front ends of the optical fibers, wherein the first optical fiber segments include stub portions that project rearwardly from the ferrules and include rear ends, and wherein the rear ends of the first optical fiber segments are spliced to the second optical fiber segments.

8. The method of claim 7, wherein each second optical fiber segment is routed on and secured to the flexible planar substrate before being spliced to its corresponding first optical fiber segment.

9. The method of claim 8, wherein each second optical fiber segment is routed on the flexible planar substrate using robotics and is secured to the substrate by adhesive.

10. The method of claim 9, wherein the adhesive includes an adhesive layer pre-applied on the flexible planar substrate, wherein the second optical fiber segments are passed through a routing needle moved by the robotics, wherein the routing needle presses the second optical fiber segments onto the adhesive layer as the second optical fiber segments are routed on the substrate.

11. The method as in claim 1, further comprising applying a layer of a fiber fixating material to the substrate.

12. The method of claim 7, wherein each second optical fiber segment is routed on and secured to the substrate after being spliced to its corresponding first optical fiber segment and after the front end of the optical fiber has been processed.

13. The method of claim 12, wherein each second optical fiber segment is routed on the substrate using robotics and is secured to the substrate by adhesive.

14. The method of claim 13, wherein the adhesive includes an adhesive layer pre-applied on the substrate, wherein the second optical fiber segments are passed through a routing needle moved by the robotics, wherein the routing needle presses the second optical fiber segments onto the adhesive layer as the second optical fiber segments are routed on the substrate.

15. The method of claim 14, further comprising applying a layer of an elastomer to the substrate, wherein the elastomer is cured after the second optical fiber segments have been routed on the substrate.

16. The method of claim 1, wherein the optical fibers include stub portions that extend rearwardly from the ferrules, and wherein the stub portions are routed on and secured to the substrate after the front end of the optical fiber has been processed.

17. The method of claim 16, wherein each of the stub portions is routed on the substrate using robotics and is secured to the substrate by adhesive.

18. The method of claim 17, wherein the adhesive includes an adhesive layer pre-applied on the substrate, wherein the stub portions are applied to the substrate by a routing needle moved by the robotics.

19. The method of claim 18, further comprising applying a layer of an elastomer to the substrate, wherein the elastomer is cured after the stub portions have been routed on the substrate.

20.-29. (canceled)

30. A method of making a flexible optical circuit device, the flexible optical circuit device including a flexible substrate supporting a plurality of optical fibers secured to the flexible substrate, the optical fibers including front ends, the method comprising:
processing the front ends of the optical fibers before the optical fibers are incorporated as part of the flexible optical circuit device.

31. The method of claim 30, wherein the flexible substrate is planar.
